(19) United States
(12) Patent Application Publication
(10) Pub. No.: US 2010/0151211 A1
(43) Pub. Date: Jun. 17, 2010

(54) THIN FILM DEVICE, METHOD OF MANUFACTURING THIN FILM DEVICE, AND ELECTRONIC APPARATUS

(75) Inventors: Taimei Kodaira, Chino-shi (JP); Yuko Komatsu, Suwa-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/631,036

(22) Filed: Dec. 4, 2009

(30) Foreign Application Priority Data
Dec. 12, 2008 (JP) 2008-316850

(51) Int. Cl. B32B 3/02; B32B 38/10

(52) U.S. Cl. 428/192; 156/247

(57) ABSTRACT

Provided is a method of manufacturing a thin film device which includes a thin film body and a substrate supporting the thin film body including forming a thin film body on a first substrate; bonding the thin film body to a second substrate; and transferring the thin film body onto the second substrate by detaching the first substrate from the thin film body. In the method, the thin film body has a plurality of corners in a top view and at least one corner of the plurality of corners is chamfered, and the first substrate is peeled off from a portion where the one corner contacts therewith, in the transferring of the thin film body.

### BACKGROUND

1. Technical Field

The present invention relates to a thin film device having a thin film body such as a thin film element (for example, a thin film transistor), a method of manufacturing the same, and an electronic apparatus including the thin film device.

2. Related Art

A thin film device that is provided with a thin film element and the like on a substrate is known and is used for various applications. Examples of the substrate that constitutes such a thin film device include a silicon wafer, a glass substrate, a resin film, a metal substrate, and the like. When a resin film is used as a substrate or when one of a metal substrate, a glass substrate, a silicon wafer and the like that are formed by thinning the thickness thereof is used as a substrate, the substrate has flexibility. For this reason, a thin film device which has flexibility and light weight can be provided. The use of the thin film device with such characteristics can realize a display device, which is so called, for example, a flexible display (for example, an electronic paper and the like).

There are several examples in methods of manufacturing the thin film device. Specifically, there have been suggested the following methods: (1) a method of directly forming a thin film element on a substrate; (2) a method which uses a transferring technique of forming a thin film element on a glass substrate of high heat-resistance at first, and adhering (bonding) the thin film element to a substrate such as a resin film by separating (peeling) the thin film element from the glass substrate (see JP-A-10-125929 and JP-A-10-125930, for example); and (3) a method of forming a thin film element on one side of a glass substrate of high heat-resistance, thinning the other side of the glass substrate by grinding or etching, and then adhering (bonding) the thinned glass substrate and the thin film element onto another substrate such as a resin film.

When deformation such as bending of a thin film device occurs, a bending stress is generated in a thin film element. Generally, since a great stress may be generated even with a small deformation in a thin film layer having an elastic constant of several tens GPa, the thin film element may be fractured by the stress resulting from deformation such as bending. This vulnerability is all the more noticeable in a flexible thin film element. Particularly, there is a case where a fine crack or notch exists at the edge of the thin film element due to cutting performed in a manufacturing process. In a spot with the crack or notch, the fracture can occure because an enormous stress is locally generated with ease when the elastic limit of a material itself is noticeably lowered and the stress is concentrated.

With regard to such a point, JP-A-2006-303166 suggests a technique of resolving the vulnerability without forming an inorganic insulating film in a cut region where a number of thin film devices that have been formed in advance are cut into individual pieces when the thin film devices are manufactured by using the transferring technique. However, in that case where the thin film device is manufactured by using the related art, when a thin film element that has been formed on a first substrate in advance is transferred onto a second substrate, the edges of the thin film element (particularly, the four corners thereof) may often be fractured without being normally peeled from the first substrate. In addition, the edges of the thin film element (particularly, the four corners thereof) are susceptible to fracture during use of the thin film device, whether or not the above-described transferring technique has been employed. For this reason, there is a demand for a new technique of suppressing damage on the thin film element during the manufacture or use of the thin film device.

### SUMMARY

An advantage of some aspects of the invention is that it provides a technique of suppressing damage on a thin film element during the manufacture or use of a thin film device.

According to a first aspect of the invention, there is provided a method of manufacturing a thin film device which includes a thin film body and a substrate supporting the thin film body. The method includes forming a thin film body on a first substrate, bonding the thin film body to a second substrate, and transferring the thin film body onto the second substrate by detaching the first substrate from the thin film body. In the method, the thin film body has a plurality of corners in a top view and at least one corner of the plurality of corners is chamfered and the first substrate is peeled off from a portion where the one corner contacts therewith, during the transferring of the thin film body.

In the present specification, the “thin film body” refers to, for example, a thin film diode, a photoelectric conversion element (a photo-sensor, or a solar cell) formed of a PIN junction of silicon, a silicon resistive element, other thin film semiconductor devices, an electrode (for example, a transparent electrode such as an ITO, a mesa layer, and the like), a switching element, a memory, an actuator such as piezoelectric element, a micromirror (piezo thin-film ceramics), a thin-film magnetic recording head, a coil, an inductor, a thin-film high-permeability magnetic material and a micro magnetic device combining therewith, a filter, a reflective film, a dichroic mirror and the like, in addition to a thin film transistor. Such a thin film element (thin film device) is generally formed at a relatively high processing temperature in the forming method.

According to the above-described aspect of the manufacturing method, at least one corner of the plurality of corners is chamfered, and the first substrate is peeled from the corner. Therefore, a physical impact on the corner applied during the manufacture is alleviated and damage on the thin film element included in the thin film body can be suppressed.

According to the aspect of the manufacturing method, it is preferable that the one corner of the thin film body has a projection protruding outward from the thin film body in a top view.

By providing the projection, it is possible to enhance the effect of alleviating the impact on the corner when the first substrate is peeled off from the thin film body.

According to the aspect of the manufacturing method, the plurality of corners of the thin film body all may be chamfered.

Accordingly, it is possible to alleviate the impact on the corner of the thin film body and to enhance the effect of suppressing damage.

According to a second aspect of the invention, there is provided a thin film device including a substrate, and a thin film body provided on one side of the substrate. In the thin film device, the thin film body has a plurality of corners in a top view and at least one corner of the plurality of corners is chamfered.

According to the above-described aspect of the thin film device, the thin film body has at least one corner which is chamfered. Therefore, it is possible to alleviate a physical impact on the corner during the use of the thin film device and to suppress damage on the thin film element included in the thin film body.

According to the above-described aspect, an adhesive layer may be provided between the substrate and the thin film body. In other words, the substrate and the thin film body may be bonded via the adhesive layer interposed therebetween.

According to the above-described aspect, the one corner of the thin film body may include a projection protruding outward from the thin film body in a top view.

By providing the projection, it is possible to further enhance the effect of alleviating the impact on the corner when the first substrate is peeled off from the thin film body.

According to the above-described aspect, the plurality of corners of the thin film body all may be chamfered.

Accordingly, it is possible to alleviate the impact on the corner of the thin film body and to enhance the effect of suppressing damage.

According to a third aspect of the invention, an electronic apparatus is configured to include the thin film device according to the invention. Specifically, the electronic apparatus according to the invention is provided with, for example, a display device such as a liquid crystal device using the above-described thin film device as a display section. Here, the “electronic apparatus” includes a display device, a television set, an electronic paper, a watch, a calculator, a mobile phone, a portable information terminal, and the like.

### BRIEF DESCRIPTION OF THE DRAWINGS

The invention will be described with reference to the accompanying drawings, wherein like numbers reference like elements.

FIG. 1 is a top view schematically illustrating a substrate on which a number of thin film bodies are formed.

FIG. 2 is a cross sectional view illustrating an enlarged part of the substrate shown in FIG. 1.

FIGS. 3A to 3D are top views illustrating each of the thin film bodies in detail.

FIG. 4 is a top view illustrating an example of another configuration of a thin film body.

FIG. 5 is a partial perspective view schematically illustrating the appearance of transferring.

FIGS. 6A to 6D are cross sectional views schematically illustrating an example of a method of manufacturing a thin film body.

FIGS. 7A to 7C are cross sectional views schematically illustrating the example of the method of manufacturing the thin film body.

FIGS. 8A to 8C are perspective diagrams schematically illustrating examples of an electronic apparatus.

### DESCRIPTION OF EXEMPLARY EMBODIMENTS

Hereinafter, an exemplary embodiment of the invention will be explained in detail with reference to the accompanying drawings.

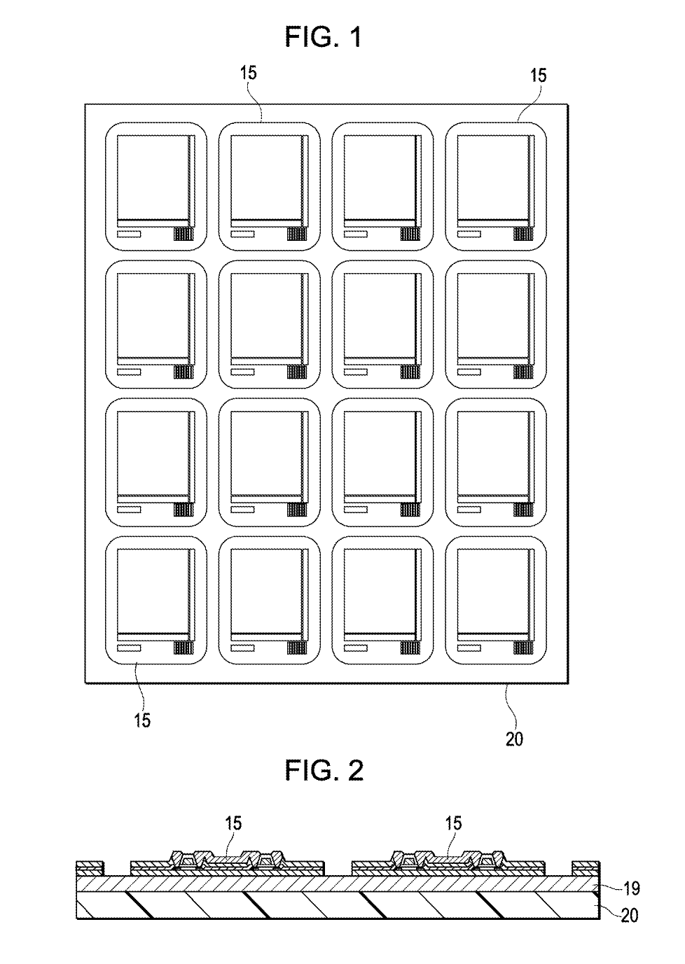

FIG. 1 is a top view schematically illustrating a substrate on which a number of thin film bodies are formed. FIG. 2 is a cross sectional view schematically illustrating an enlarged part of the substrate shown in FIG. 1. A substrate 20 having a number of thin film bodies 15 shown in FIG. 1 and FIG. 2 is obtained by forming each of the thin film bodies 15 on a substrate (not shown) as a transferring source, transferring the thin film bodies to a temporary transfer substrate, and further transferring the thin film bodies to the substrate 20 as a final substrate. Each of the thin film bodies 15 includes, for example, a thin film element such as a thin film transistor, a wiring and the like, exhibits its own predetermined functions, and is provided on the substrate 20 via an adhesive layer 19 interposed therebetween as shown in FIG. 2. These thin film bodies 15 are separated into each thin film body 15 by a cutting process. A manufacturing method thereof will be described later in detail. In the present embodiment, each of the thin film bodies 15 includes a thin film transistor, a wiring (a scanning line, and a signal line), a pixel circuit unit that includes components such as a pixel electrode, a driver that supplies a driving signal to the pixel circuit unit, an input terminal that transmits electric power, a signal and the like to the driver from outside, and the like. The thin film body is a thin film circuit used as a constituting component in a liquid crystal device or an electrophoretic device. Moreover, that is just an example of the thin film body 15.

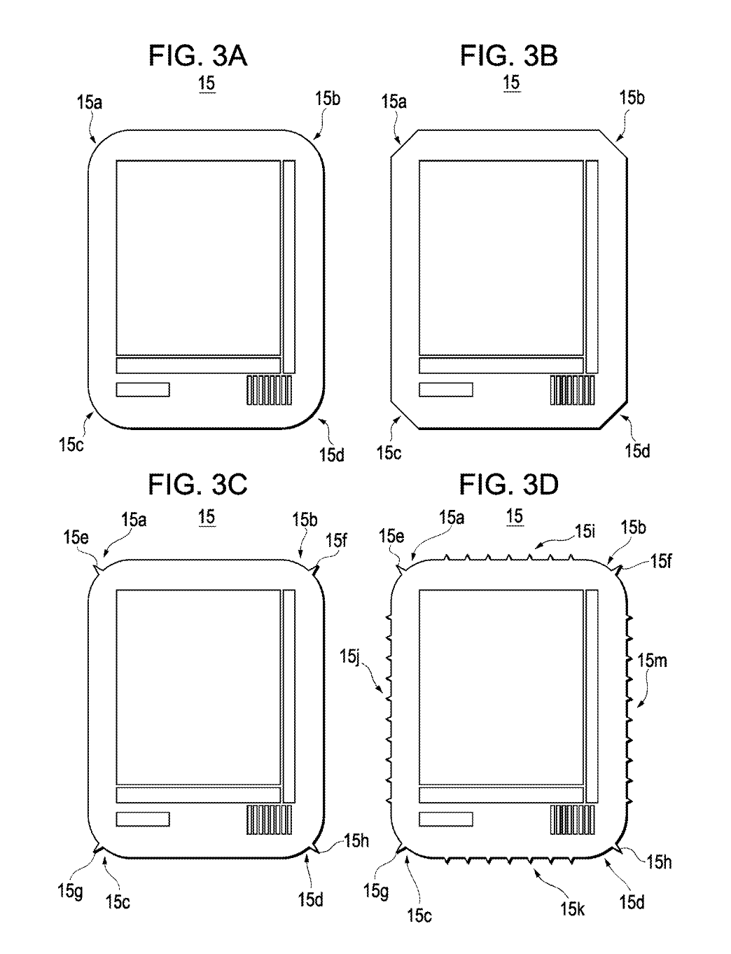

FIGS. 3A to 3D are top views illustrating some examples of the thin film body 15 in detail. The thin film body 15 shown in FIG. 3A has four corners (edges) 15a, 15b, 15c, and 15d each of which is chamfered so as to have an outer edge with a circular arc shape (a round shape). The thin film body 15 shown in FIG. 3B has four corners 15a to 15d each of which is chamfered so as to have an outer edge with a straight line shape (a polygonal shape). By chamfering the corner of the thin film body 15 (a shape formed by removing the corners), it is possible to disperse a physical impact on the corner and to suppress damage during the manufacture or the use of the thin film device. In other words, it is possible to improve impact resistance thereof.

As shown in FIG. 3C, each of the corners 15a to 15d of the thin film body 15 may be provided with even smaller projections 15e, 15f, 15g, and 15h. Furthermore, as shown in FIG. 3D, outer edges other than each of the corners 15a to 15d of the thin film body 15 may be provided with small projections 15i, 15j, 15k and 15m. Each of the projections 15e and the like has a shape protruding outward from the thin film body 15. Having small projections in each of the corners or other outer edge portions of the thin film body 15 may have the effect described above to be enhanced. In addition, shapes shown in FIG. 3A to FIG. 3D are just examples, and various other shapes may be employed.

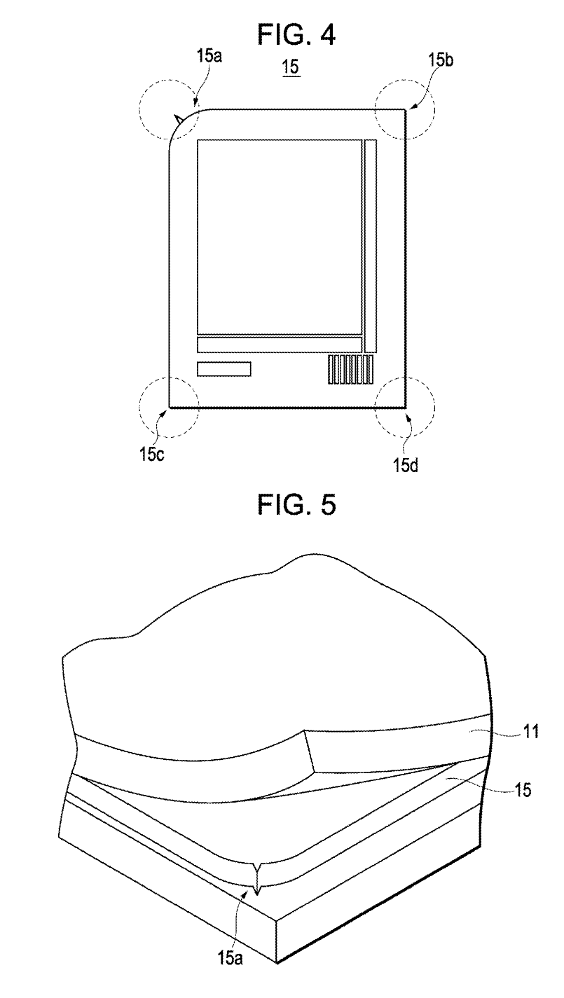

FIG. 4 is a top view illustrating another example of the thin film body. When the thin film body 15 according to the present embodiment is manufactured by using the transferring technique, at least one corner out of the four corners 15a to 15d of the thin film body 15 may be chamfered. In the example of FIG. 4, only one corner 15a is chamfered. In this case, when the thin film body 15 is transferred from a first substrate 11 as an original manufacturing substrate to the other substrate, the first substrate 11 may be peeled off from the corner 15a which is the only one corner chamfered. FIG. 5 is a partial perspective view schematically illustrating the appearance of transferring. By peeling off the first substrate 11 from the corner 15a which is chamfered as in the drawing, it is possible to be sure of avoiding damage on the thin film body 15. Furthermore, in the example, by providing the projection 15e in the corner 15a, it is possible to enhance the effect of avoiding the damage on the thin film body 15. In addition, chamfering may be performed in other corners 15b, 15c, and 15d, and the projection 15e may be omitted.

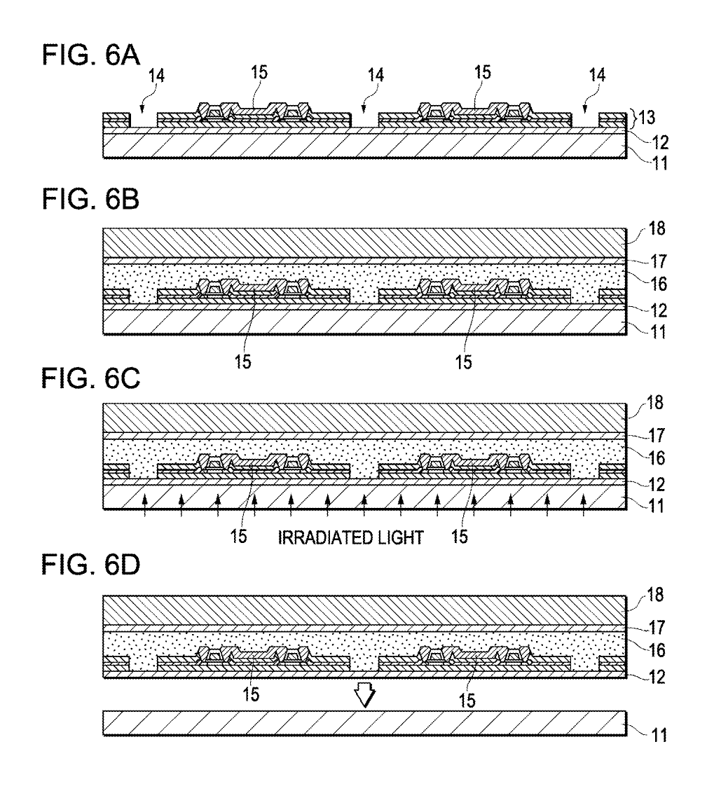

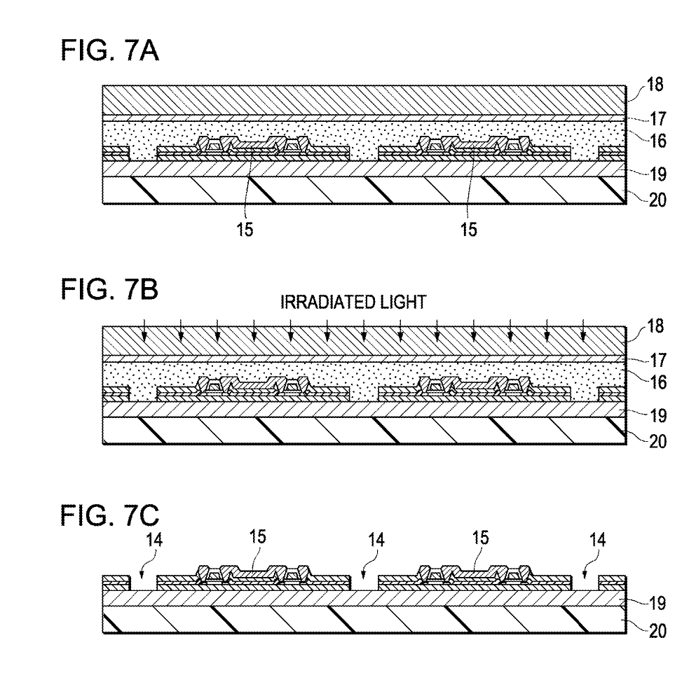

FIGS. 6A to 6D, and FIGS. 7A to 7C are cross sectional views schematically illustrating an example of a method of manufacturing a thin film body. The thin film body 15 according to the present embodiment may be preferably manufactured by using the transferring technique, for example. Detailed explanation thereof will be provided below.

At first, a thin film element layer 13 having a number of the thin film bodies 15 is formed on the first substrate 11 as an original transfer substrate via a peeling layer 12 interposed therebetween (see FIG. 6A). As shown in the drawing, the thin film element layer 13 has boundary regions 14 provided between each of the thin film bodies 15. Each of the thin film bodies 15 is formed so as to have chamfered corners as described above (see FIGS. 3A to 3D and FIG. 4).

Here, the first substrate 11 is preferably formed of a material with high reliability. Particularly, it is preferable that the material have excellent heat resistance. The reason is as follows; a processing temperature gets higher sometimes (for example, from about 350° C. to about 1000° C.) depending on the kind of the material or the forming method when the peeling layer 12 and the thin film element layer 13 are formed. Specifically, it is preferable that a deformation point of the constituting material of the first substrate 11 is higher than 350° C., and it is more preferable that the deformation point is higher than 500° C.

The peeling layer 12 absorbs light irradiated thereon, and has a property that peeling occurs in at least one of the inside of the layer or the interface thereof. As an example of the peeling layer 12, an amorphous silicon film may be preferably used. The thin film element layer 13 is configured to include the above-described thin film body 15 having a thin film element such as a thin film transistor.

Next, as shown in FIG. 6B, a temporary adhesive layer 16 is formed on the thin film element layer 13. A temporary transfer substrate 18 as a second substrate is bonded to the first substrate 11 via the temporary adhesive layer 16 interposed therebetween. Here, as shown in the drawing, a peeling layer 17 is preferably provided in a side of the temporary transfer substrate 18 that faces toward the temporary adhesive layer 16. The peeling layer 17 is the same as the peeling layer 12 described above. Since the temporary adhesive layer 16 will be removed in a later process, it is preferable that the layer be formed of a water-soluble adhesive material that may be removed with ease.

Next, as shown in FIG. 6C, light is irradiated from the rear side of the first substrate 11 toward the peeling layer 12. Accordingly, peeling occurs in the peeling layer 12 and thereby bonding force is decreased or diminished. Here, the irradiated light is, for example, a laser beam. Accordingly, as shown in FIG. 6D, the first substrate 11 can be separated. At this point, as shown in FIG. 5 above, the first substrate 11 is peeled off from one corner of the thin film body 15. When only one of the four corners of the thin film body 15 is chamfered, the first substrate 11 is peeled off from the chamfered corner side.

It is presumed that the peeling occurs in the peeling layer 12 because ablation occurs in the constituting material of the peeling layer 12, gas contained in the peeling layer 12 is discharged, or a phase-change such as melting, transpiration or the like occurs right after the irradiation of the light. Here, the ablation means that an anchoring material (constituting material of the peeling layer 12) that absorbed the irradiated light is photochemically or thermally excited, and thereby the bond between atoms or molecules on the surface of or inside the material is severed in order to discharge the atoms or molecules. Generally, the ablation occurs as a phenomenon where all or part of the constituting material of the peeling layer 12 shows a phase-change such as melting, transpiration (vaporization), or the like. Furthermore, the material is in a state of microscopic foam due to the phase-change, thereby the bonding force deteriorates. Examples of the irradiated light may be any thing that causes peeling in the peeling layer 12, such as X-rays, ultraviolet rays, visible light, infrared rays (heat rays), laser light, millimeter waves, micro waves, electron beams, radioactive rays (α-rays, β-rays, and γ-rays), and the like. Among these, the laser light is preferable in that it easily causes ablation of the peeling layer 12.

When all or part of the peeling layer 12 remains on the thin film element layer 13, the peeling layer 12 may be removed by methods of, for example, cleaning, etching, ashing, grinding, and the like, or a combined method thereof.

Next, as shown in FIG. 7A, the adhesive layer 19 is formed on the rear side of the thin film element layer 13, and the thin film element layer 13 is bonded to the transfer substrate 20 via the adhesive layer 19 interposed therebetween. A plastic substrate may be used for the transfer substrate 20, for example.

Next, as shown in FIG. 7B, light is irradiated from the upper side of the temporary transfer substrate 18. The irradiated light transmits the temporary transfer substrate 18 to be irradiated to the peeling layer 17 causing peeling in the peeling layer 17. As a result, the temporary transfer substrate 18 can be removed. The remaining peeling layer 17 is removed by a method such as etching if necessary. In addition, the temporary adhesive layer 16 is removed by cleaning with water, for example. With the above process, the plurality of the thin film bodies is transferred onto the transfer substrate 20 as shown in FIG. 7C.

Thereafter, each thin film body 15 can be obtained by cutting out the thin film body 15 in the boundary region 14 with a method such as dicing. Because the inorganic material layer is removed in the boundary region 14 as described above, it is possible to avoid any crack on a cut face. Consequently, the fracture of the thin film body 15 can be prevented.

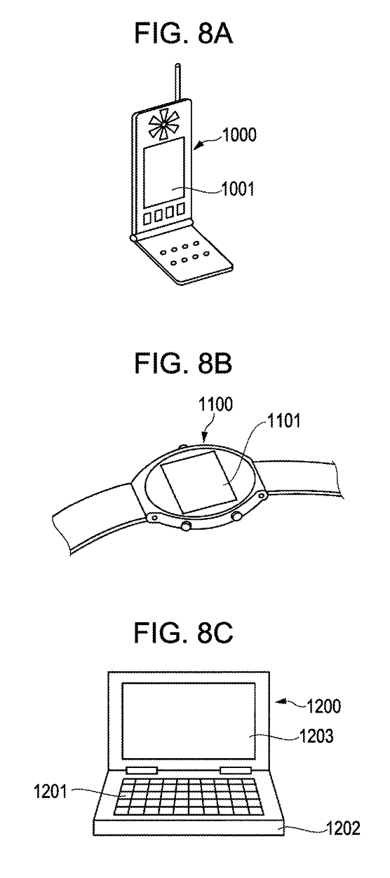

Next, specific examples of an electronic apparatus that includes the above-described thin film device will be described. FIGS. 8A to 8C are perspective diagrams illustrating specific examples of an electronic apparatus having a display section configured by using a thin film device. FIG. 8A is a perspective diagram illustrating a mobile phone as an example of the electronic apparatus. The mobile phone 1000 is provided with a display section 1001 configured by using the thin film device according to the present embodiment. FIG. 8B is a perspective diagram illustrating a wrist watch as an example of the electronic apparatus. The wrist watch 1100 is provided with a display section 1101 configured by using the thin film device according to the present embodiment. FIG. 8C is a perspective diagram illustrating a portable information-processing device 1200 as an example of the electronic apparatus. The portable information-processing device 1200 is provided with an input section 1201 such as keyboard or the like, a body 1202 that includes a calculating unit, a memory unit and the like, and a display section 1203 configured by using the thin film device according to the present embodiment.

According to the above-described embodiment, since at lease one of the corners of the thin film body is chamfered, it is possible to alleviate a physical impact on the corner during the manufacture or use of the thin film device, thereby damage on the thin film element included in the thin film body can be suppressed.

The invention is not limited to the above-described embodiment, but may be modified in various ways within the scope or intention of the invention. For example, in the above-described embodiment, the use of the transferring technique is explained as a preferable example of the method of manufacturing a thin film body, but the manufacturing method of the thin film body is not limited thereto. In addition, in the above-described embodiment, a case where a thin film device is used as a constituting element of a display device was exemplified, but the application of the thin film device is not limited thereto.

The entire disclosure of Japanese Patent Application No. 2008-316850, filed Dec. 12, 2008 is expressly incorporated by reference herein.

What is claimed is:

1. A method of manufacturing a thin film device which includes a thin film body and a substrate supporting the thin film body, the method comprising,
forming a thin film body on a first substrate;
bonding the thin film body to a second substrate; and
transferring the thin film body onto the second substrate by detaching the first substrate from the thin film body;
wherein the thin film body has a plurality of corners in a top view and at least one corner of the plurality of corners is chamfered; and
the first substrate is peeled off from a portion where the one corner contacts therewith, in the transferring of the thin film body.

2. The method of manufacturing the thin film device according to claim 1, wherein the one corner has a projection protruding outward from the thin film body in a top view.

3. The method of manufacturing the thin film device according to claim 1, wherein the plurality of corners of the thin film body is all chamfered.

4. A thin film device comprising,
a substrate; and
a thin film body provided on the substrate;
wherein the thin film body has a plurality of corners in a top view and at least one corner of the plurality of corners is chamfered.

5. The thin film device according to claim 4, further comprising an adhesive layer provided between the substrate and the thin film body.

6. The thin film device according to claim 4, wherein the one corner includes a projection protruding outward from the thin film body in a top view.

7. The thin film device according to claim 4, wherein the plurality of corners of the thin film body is all chamfered.

8. An electronic apparatus comprising a thin film device, the thin film body comprising,
a substrate; and
a thin film body provided on one side of the substrate;
wherein the thin film body has a plurality of corners in a top view and at least one corner of the plurality of corners is chamfered.
